(19) United States
(12) Patent Application Publication
(10) Pub. No.: US 2008/0010988 A1
(43) Pub. Date: Jan. 17, 2008

(54) Component protection method and control device for a supercharged internal combustion engine

(75) Inventors: Andreas Sterner, Moeglingen (DE); Matthias Hofstetter, Ringsheim (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c.F. Porsche Aktiengesellschaft, Stuttgart (DE)

(21) Appl. No.: 11/703,813

(22) Filed: Feb. 8, 2007

(30) Foreign Application Priority Data
Feb. 25, 2006 (DE) 10 2006 008 855.7

(51) Int. Cl. F02D 41/22

(52) U.S. Cl. 60/611

(57) ABSTRACT

A process controls filling of combustion spaces of an internal combustion engine that has at least one filling control element and one exhaust gas turbocharger whose turbine geometry can be adjusted by an electrical positioning element. In a base position of an electrical positioning element, a basic charging pressure is provided. When there is a possible or actual faulty displacement of the electrical positioning element, filling of the combustion spaces is limited by driving the filling control element. A control device controls the execution of the process.

This application claims priority to German Patent Application No. 10 2006 008 855.7, filed Feb. 25, 2006, the disclosure of which is incorporated herein in its entirety.

### BACKGROUND AND SUMMARY OF THE INVENTION

The present invention relates to a process for controlling filling of combustion spaces of an internal combustion engine having at least one filling control element and one exhaust gas turbocharger whose turbine geometry can be adjusted by an electrical positioning element that, in its base position, provides a basic charging pressure. The present invention relates furthermore to a control device which controls the execution of the process.

A control device and a process of the foregoing general type are disclosed in DE 102 24 051. The known process is used with an exhaust turbocharger in whose turbine wheel exhaust gas from the internal combustion motor flows through an annular cross section. Impeller blades are disposed in the annular cross section. The electrical positioning element adjusts the position of these impeller blades and thus changes the flow cross section usable by the exhaust gases as well as the flow direction of the exhaust gases. With this known method, the energy transfer from the exhaust gas to the turbine wheel is ultimately influenced.

In a base position of the electrical positioning element, the impeller blades are set so that, with reference to the turbine wheel, a large flow cross section for the exhaust gases results. The damming behavior of the turbine is low in this state. The energy transfer is then minimal and the exhaust gas turbocharger provides the basic charging pressure.

With increasing displacement of the electrical positioning element the flow cross section becomes smaller and the damming behavior of the turbine becomes greater. With this change, the enthalpy gradient of the exhaust gas over the turbine ultimately increases, and, consequently, the energy transferred to the turbine wheel. The charging pressure thereby also increases.

With increasing charging pressure the combustion space mixture or filling increases, and, with corresponding fuel dosing, the torque developed by the internal combustion engine also increases. In an internal combustion engine in a motor vehicle a driver's demand for torque in a functional system is realized by coordinated control of the filling control element and the charging pressure. When there is faulty displacement of the electrical positioning element, however, the charging pressure is too high and too much torque is generated.

In the known approach, the electrical positioning element is coupled via a spring-loaded mechanism to the impeller blades. The electrical positioning element must displace the impeller blades from their base position against the spring force. An advantage of the approach is that an automatic restoration of the impeller blades into their base position, and therewith an automatic establishment of the basic charging pressure, follows if a power failure occurs when the electrical positioning element is displaced. Without the spring force, however, the positioning element would then, under certain circumstances, remain in a displaced position due to the restraining frictional forces.

Internal combustion engines with exhaust gas turbochargers, as a consequence of their operating principle, have a delayed reaction to a driver's demand for rapidly increasing torque. The delay is reduced in systems with variable turbine geometry due to the fact that for a rapid increase in torque the impeller blades are set to a position with increased energy transfer of exhaust gas to the turbine wheel. The turbine wheel is then accelerated more strongly and the charging pressure increases more rapidly. Restoring forces occurring in the mechanism reduce the speed with which the impeller blades can be displaced into the desired position.

Against this background, an object of the present invention is to provide a process that limits the torque when there is an actual or possible faulty displacement of the electrical positioning element in connection with a more rapid displacement of the impeller blades. Such a faulty displacement can, for example, occur when there is an electrical fault of the electrical positioning element or its power supply or due to mechanical faults, e.g., a mechanical jamming of the electrical positioning element or of the displacement mechanism involved.

This object has been achieved by a process in which, when there is a possible or actual faulty displacement of the electrical positioning element, fillings of the combustion spaces are limited by driving the filling control element. Furthermore, this object is realized in a control device by the fact that it drives the filling control element accordingly.

The limiting of the mixture or filling via the filling control element also limits the filling when charging pressure has increased due to a fault. Thus, springs or other elastic elements that apply the mechanical restoring force are omitted. As a consequence, when a driver demands a rapidly increasing torque, more rapid increase in charging pressure then follows with the same displacement force and/or the same positioning element without the danger that, when there is a faulty displacement of the electrical positioning element, combustion space fillings which are too great are generated.

Other objects, advantages and novel features of the present invention will become apparent from the following detailed description of the invention when considered in conjunction with the accompanying drawings, in which:

### BRIEF DESCRIPTION OF THE DRAWINGS

FIG. 1 is a schematic diagram of an internal combustion engine with a turbocharger with variable turbine geometry,

FIG. 2 is a schematic cross-sectional view showing the variation of the turbine geometry, and

FIG. 3 is a flow diagram illustrating an embodiment of the process according to the present invention.

### DETAILED DESCRIPTION OF THE DRAWINGS

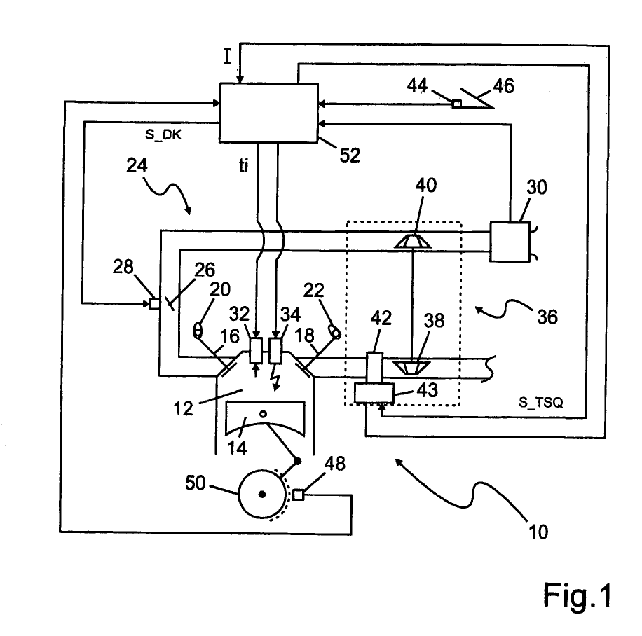

FIG. 1 shows an internal combustion engine 10 with at least one combustion space 12 that is movably sealed by a piston 14. A change of filling of the combustion space 12 is controlled via an inlet valve 16 and an outlet valve 18, where the inlet valve 16 is actuated by an inlet valve positioning element 20 and the outlet valve 18 is actuated by an outlet valve positioning element 22. In one embodiment, the inlet valve positioning element 20 controls the inlet valve 16 with a variable stroke and thus serves as the respective filling control element.

When the inlet valve 16 is open, air, or a mixture of air and fuel, flows from a suction system 24 into the combustion space 12. The amount of in-flowing air, or of the in-flowing mixture, is set, alternatively or in addition to a variation of the stroke of the inlet valve 16, via a throttle 26, that is actuated by a throttle actuator 28. The filling of the combustion space is in any case decisively influenced in so doing by the pressure upstream from the throttle 26 and/or the inlet valve 16 as the respective filling control element.

The filling of the combustion space is preferably measured with a filling sensor 30, such as an air mass gauge or suction tube pressure sensor. The fuel is either dosed into the suction system 24 (suction tube injection) or injected directly into the combustion space 12 by an injector 32 (direct injection). In either case, a combustible mixture or filling of the combustion space is produced in the combustion space 12, with that mixture being ignited by a spark plug 34. Residual gases of the burned filling of the combustion space 12 are ejected via the opened outlet valve 18.

The internal combustion engine 10 shown in FIG. 1 includes an exhaust gas turbocharger 36 whose turbine wheel 38 is driven by the ejected exhaust gas and which in turn drives a compressor wheel 40 in the suction system 24. The exhaust gas turbocharger 36 furthermore has a controller 42 with an electrical positioning element 43 for controlling the geometry of the exhaust gas turbocharger 36. The electrical positioning element 43 is typically an electric motor that, in connection with a mechanism of the controller 42, produces a straight or curvilinear positioning motion.

A driver's demands for torque are detected by an encoder 44. The encoder detects the position of a gas pedal 46 of the motor vehicle. A sensor 48 for the angle of rotation reads angular markings of an encoder wheel 50 connected, in such a manner that it cannot turn, to a crank shaft of the internal combustion engine 10 and thus supplies information concerning the angular position and angular speed of the crank shaft.

It is understood that for controlling and/or regulating the internal combustion engine 10 in modern motor vehicles there can be plurality of additional sensors that detect pressures, temperatures, and angular positions of crank shafts and/or additional operating parameters of the internal combustion engine 10. The present invention is thus not restricted to use in an internal combustion engine 10 which comprises only the previously specified sensors 30, 44, 48 but contemplates all the types of engine sensors in current use. Thus, in one development the electric positioning element 43 can provide information I concerning a set blade position (that is, a check-back signal) or a result of its own diagnosis.

To control the internal combustion engine 10 the signals of the filling sensor 30, signals of the encoder 44 for the driver's demands, signals of the sensor 48 for the angle of rotation, the information I optionally present, and in given cases the signals of alternative or additional sensors are processed by a motor control device 52 that forms positioning signals to control functions of the internal combustion engine 10.

Important in this connection are control signals with which the combustion space fillings are influenced. In the embodiment of FIG. 1 these are essentially throttle positioning element signals S_DK and signals S_TSQ with which the control device 52 controls a turbine opening cross section TSQ. Moreover, the control device 52 also forms additional control signals, e.g., injection pulse widths ti.

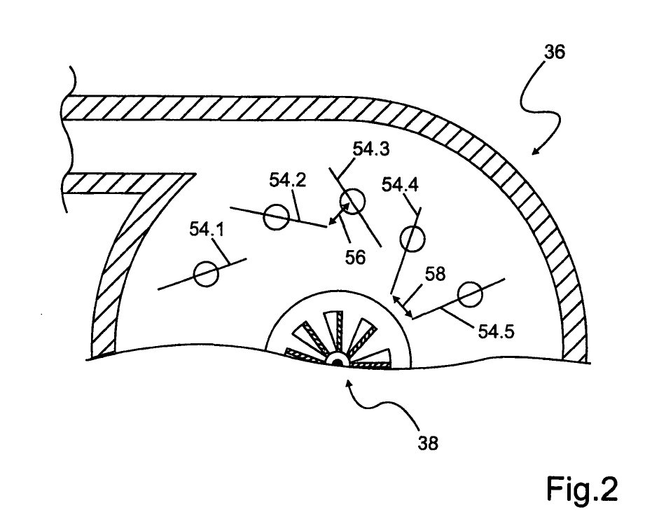

FIG. 2 shows an embodiment of a turbine of an exhaust gas turbocharger with impeller blades 54.1, 54.2, 54.3, 54.4, and 54.5 disposed in an annulus form. Contrary to the actual circumstances, in which all the impeller blades 54.1, 54.2, 54.3, 54.4, and 54.5 are set identically, the impeller blades 54.1, 54.2, and 54.3 are represented in the closed position with a small flow cross section 56 and the impeller blades 54.4 and 54.5 are represented in a wider open position with a greater flow cross section 58. The basic charging pressure is represented therein with the greater flow cross section 58. With a functional electrical positioning element 43, the impeller blades are displaced between the two extreme positions depending on the torque requirement. Details of the mechanism are not important for an understanding of the invention by one skilled in the art. It is only important to note that, when there is a power failure or another fault of the electrical positioning element 43, or even when there is jamming of the displacement mechanism or the impeller apparatus, the impeller blades can remain in a position in which an increased charging pressure is generated permanently (faulty displacement). With the filling control element wide open, excessively large combustion space fillings can occur, which without countermeasures can lead to damage to components of the internal combustion engine.

To avoid such damage, when there is a fault of the electrical positioning element 43, filling of the combustion space 12 is limited by driving the filling control element 16 and/or 26. In so doing, the driving is done such that a filling increase resulting from the increased charging pressure is at least compensated by an oppositely directed reduction of the opening of the filling control element 16 and/or 26. In contradistinction to the prior art in which the restoring spring displaces the impeller blades back into the basic charging pressure position and thus eliminates the cause of the increased charging pressure, the position of the impeller blades is not changed in a targeted manner by external forces in the present invention.

Instead, a process is provided for controlling filling of combustion spaces 12 of an internal combustion engine 10 having at least one filling control element 16 and/or 26 and one exhaust gas turbocharger 36 without an elastic restoring element. The turbine geometry of the turbocharger can be adjusted by an electrical positioning element 43 at whose base position a basic charging pressure is provided. The safety function of an elastic restoring element is replaced due to the fact that, when there is a fault of the electrical positioning element 43, fillings of the combustion space 12 are limiting by driving the filling control element 16 and/or 26.

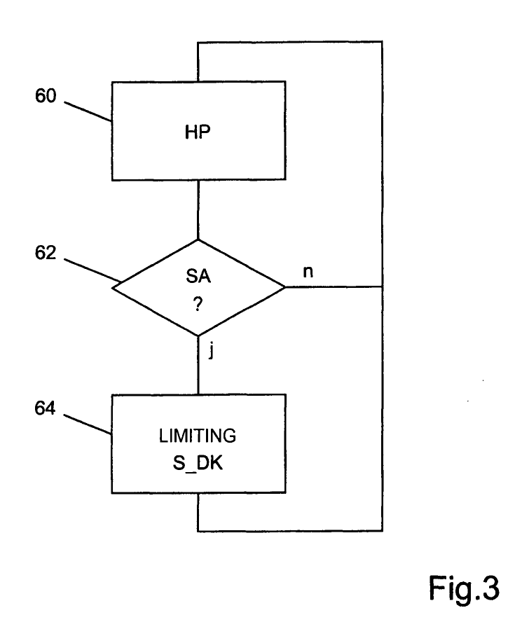

FIG. 3 is a flow chart of one embodiment of the inventive process. From a main program HP at the top of the hierarchy, which controls the internal combustion engine 10 and is represented by the step 60, the program branches into a step 62 in which an actual or possible faulty displacement of the electrical positioning element 43 is detected. An actual faulty displacement can, for example, be recognized in the fact that the check-back signal I, i.e., the actual value of the impeller blade position, deviates from a theoretical value. There is a possible faulty displacement, for example, a power failure or more generally a failure of the power supply of the electrical positioning element 43 because then the position check-back signal I is absent.

The detection is done in one embodiment by monitoring electrical operating parameters of the electrical positioning element 43. In this way, absence of the information I for the electrical positioning element 43 can be evaluated by the control device 52 as a potential faulty displacement of the electrical positioning element 43.

Alternatively or in addition, the control device 52 recognizes the power failure SA, or more generally faulty displacement, by monitoring operating parameters of the internal combustion engine 10. For this purpose, in one embodiment a first value of a measure of a combustion space filling is calculated assuming a fault-free electrical positioning element 43 and the presence of drive signals for the filling control element 16 and/or 26 and for the electrical positioning element 43. Furthermore, a second value of the magnitude of at least one measurement variable for the combustion space filling is determined. A typical measurement variable in this connection is an air mass flow, a charging pressure, or a combustion space pressure.

Subsequently, the first value is compared to the second value. An actual faulty displacement of the electrical positioning element is expressed in the fact that a difference between the second value and the first value exceeds a predefined threshold value.

When a faulty displacement is recognized, limiting of filling of the combustion space 12 by driving the filling control element 16 and/or 26 follows in step 64. The limiting is done in one embodiment with limiting of the opening angle of the throttle 26 by issuing correspondingly limited positioning signals S_DK. In addition, the permitted maximum speed of rotation of the internal combustion engine 10 can be limited. These are precisely the stationary operating ranges with high rotary speed and large throttle openings angles in which, with fault-free operation, low charging pressures can be set. Conversely, it is the case that these operating ranges are particularly critical when there is a faulty displacement of the electrical positioning element 43 with a small opening cross section of the impeller blades.

If, on the contrary, in step 62 no potential or actual faulty displacement is detected, the program returns to the main program in step 60 without limiting driving of the filling control element 16 and/or 26.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Process for controlling a filling of combustion spaces of an internal combustion engine having at least one filling control element and one exhaust gas turbocharger whose turbine geometry can be adjusted by an electrical positioning element in whose base position a basic charging pressure is provided, comprising limiting the filling of the combustion spaces by driving of the at least one filling control element when a potential or actual faulty displacement of the electrical positioning element occurs.

2. Process according to claim 1, wherein a potential or actual faulty displacement of the electrical positioning element is recognized by monitoring electrical operating parameters of the electrical positioning element.

3. Process according to claim 1, wherein an actual faulty displacement of the electrical positioning element is recognized by monitoring selected electrical operating parameters of the internal combustion engine.

4. Process according to claim 3, wherein a first value of a combustion space filling measure is calculated assuming a fault-free electrical positioning element and the presence of drive signals for the filling control element and for the electrical positioning element, a second value of the combustion space filling measure is determined from at least one measurement variable for the combustion space filling, the first value and second value are compared to one another, and an actual faulty displacement of the electrical positioning element is recognized if a difference between the second value and the first value exceeds a predefined threshold value.

5. Process according to claim 4, wherein the at least one measurement variable is one or more of an air mass flow, a charging pressure, and a combustion space pressure.

6. Control device for controlling filling of combustion spaces of an internal combustion engine having at least one filling control element and one exhaust gas turbocharger whose turbine geometry can be adjusted by an electrical positioning element in whose base position a basic charging pressure is provided, comprising means for limiting filling of the combustion spaces by driving the filling control element when a potential or actual faulty displacement of the electrical positioning element occurs.
